(19) United States
(12) Patent Application Publication
(10) Pub. No.: US 2014/0224622 A1
(43) Pub. Date: Aug. 14, 2014

(54) LOW RATE SINGULATOR

(71) Applicant: Harry Thad German, Belding, MI (US)

(72) Inventor: Harry Thad German, Belding, MI (US)

(73) Assignee: Dematic Corp., Grand Rapids, MI (US)

(21) Appl. No.: 13/947,177

(22) Filed: Jul. 22, 2013

Related U.S. Application Data
(60) Provisional application No. 61/762,646, filed on Feb. 8, 2013.

(51) Int. Cl. B65G 13/07

(52) U.S. Cl. CPC B65G 13/07
USPC 198/790

(57) ABSTRACT

A conveyor singulator includes a conveying surface defined by a plurality of lanes, each made up of freely rotatable rollers that are skewed with respect to a longitudinal direction. A drive system for each of the lanes is adapted to driving the rollers in that lane. The drive system includes an endless belt, a motor assembly that is adapted to propel the belt and a plurality of guide assemblies that are each adapted to bias the belt against the rollers. Each guide assembly includes a stationary block of low-friction polymers and a support that is adapted to press the block against an upper run of the belt to press the belt against the rollers in that lane.

### CROSS-REFERENCE TO RELATED APPLICATIONS

This application claims priority to U.S. provisional patent application Ser. No. 61/762,646 filed Feb. 8, 2013, the disclosure of which is hereby incorporated herein by reference in its entirety.

### BACKGROUND OF THE INVENTION

The present invention is directed to a conveyor and, in particular, to a singulator that is adapted to unscramble side-by-side packages into a single file.

Unscramblers or singulators are usually made up of one or more lanes of skewed rollers that are driven by various forms of drive systems, such as propelled endless drive belts. Such endless belt must be brought into contact with the rollers. Known techniques for biasing the drive belt against the rollers tends to create a large load on the drive belt thus increasing the horsepower requirement of the drive motor and leading to frequent need to replace the belt.

### SUMMARY OF THE INVENTION

The present invention, as set forth in the claims below, is directed to a conveyor, such as a singulator, that is propelled by a drive system that is capable of biasing a drive belt against rollers in a manner that greatly reduces friction in the system. This leads to reduction in horsepower requirement and lengthen belt life.

A conveyor, according to an aspect of the invention, includes a conveying surface defined by a plurality of freely rotatable rollers and a drive system that is adapted to drive the rollers. The drive system includes an endless belt, a motor assembly that is adapted to propel the belt and a guide assembly that is adapted to bias the belt against the rollers. The guide assembly includes a stationary block of a low-friction polymer and a support that is adapted to press the block against an upper run of the belt to press the belt against the rollers.

A guide channel may be formed in the block, the channel having a footprint that is approximately the width of the belt. The support may include a spring that is adapted to press the block upwardly.

The support may have a drive mode in which the belt is pressed against the rollers and a neutral mode in which the belt is not pressed against the rollers. The support may include a controllable actuator, such as a pneumatic cylinder.

A plurality of guide assemblies may be spaced along the conveying surface. The rollers may be skewed. The belt may be a V-shaped belt in cross section. The low-friction polymer may be a tivar material.

A conveyor, according to another aspect of the invention, includes a conveying surface defined by a plurality of lanes, each comprising freely rotatable rollers that are skewed with respect to a longitudinal direction, wherein the conveying surface in each of the lanes is driven at a different speed from other of said lanes and a drive system for each of the lanes. The drive system is adapted to drive the rollers in that lane. The drive system includes an endless belt, a motor assembly that is adapted to propel the belt and a guide assembly that is adapted to bias the belt against the rollers. The guide assembly includes a stationary block of low-friction polymers and a support that is adapted to press the block against an upper run of the belt to press the belt against the rollers in that lane.

A guide channel may be formed in the block, the channel having a footprint that is approximately the width of the belt. The support may include a spring that is adapted to press the block upwardly.

The support may have a drive mode in which the belt is pressed against the rollers and a neutral mode in which the belt is not pressed against the rollers. The support may include a controllable actuator, such as a pneumatic cylinder.

A plurality of guide assemblies may be spaced along the conveying surface. The belt may be a V-shaped belt in cross section. The low-friction polymer comprises a tivar material. At least some of the rollers may include a driving surface and a driven surface, with the driven surface having a larger diameter than the driving surface thereby producing a speed increase with respect to other of the rollers in that lane. The driven surface may be defined by a polymeric sleeve slid over a roller defining said driving.

These and other objects, advantages and features of this invention will become apparent upon review of the following specification in conjunction with the drawings.

### BRIEF DESCRIPTION OF THE DRAWINGS

FIG. 1 is a top plan view of a conveyor, according to an embodiment of the invention;

FIG. 2 is the same view as FIG. 1 with a portion of the conveying surface removed to reveal the drive system;

FIG. 3 is side elevation view of the conveyor in FIG. 1;

FIG. 4 is the same view as FIG. 1 of an alternative embodiment;

FIG. 5 is a sectional view taken along the lines V-V in FIG. 1;

FIG. 6 is a sectional view taken along the lines VI-VI in FIG. 1;

FIG. 7 is a sectional view taken along the lines VII-VII in FIG. 1;

FIG. 8 is an end elevation of a guide assembly in a drive mode;

FIG. 9 is the same view as FIG. 8 with the guide assembly in a neutral mode;

FIG. 10 is a side elevation view of a drive system;

FIG. 11 is a top plan view of the drive system in FIG. 10;

FIG. 12 is a top plan view of a block;

FIG. 13 is an end elevation view of the block in FIG. 12;

FIG. 14 is a top plan view of a tray for the block in FIG. 12;

FIG. 15 is an end elevation view of the tray in FIG. 14;

FIG. 16 is an exploded side elevation view of an alternative embodiment of a guide assembly with components separated to reveal details thereof;

FIG. 17 is a perspective view of the tray backing for the guide assembly in FIG. 16;

FIG. 18a is a perspective view of a roller;

FIG. 18b is an end elevation view of the roller in FIG. 18a;

FIG. 19a is a perspective view of an alternative embodiment of a roller; and

FIG. 19b is an end elevation view of the roller in FIG. 19a.

### DESCRIPTION OF THE PREFERRED EMBODIMENT

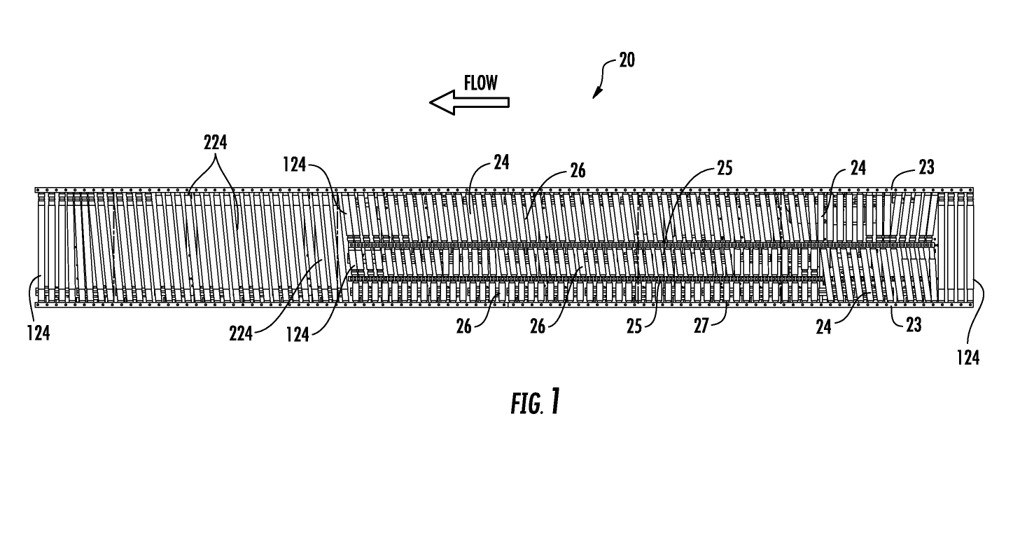

Referring now to the drawings and the illustrative embodiments depicted therein, a conveyor 20 includes a conveying surface 22 made up of rollers 24, a frame 23 supporting the conveying surface and a drive system 28 propelling rollers 24 of conveying surface 22. Rollers 24 are supported by support rails 25. In the illustrative embodiment, conveyor 20 is a low rate singulator that is made up of a plurality of lanes 26, each made up of skewed rollers that are driven at different speeds. The purpose is to unscramble side-by-side packages, or articles, against an alignment edge 27, which is referred to in the art as singulation. Alignment edge 27 is a vertical surface that may include a series of passive or driven conveying members, such as short rollers. Such singulator utilizes the principles set forth in more detail in commonly assigned U.S. Pat. No. 5,415,281, the disclosure of which is hereby incorporated herein by reference. In the embodiment shown in FIG. 1, articles are singulated to the left side of conveyor 20 in the direction of article flow. Lane 26 closest to alignment edge 27 is driven at the highest speed, such as 205 feet per minute (fpm), the middle lane 26 at an intermediate speed, such as 250 fpm, and the most distant lane 26 from alignment edge 27 is driven at the slowest speed, such as 210 fpm. These speeds are only examples of possible speeds. Also, rollers are skewed toward the left to assist movement of articles toward alignment edge 27.

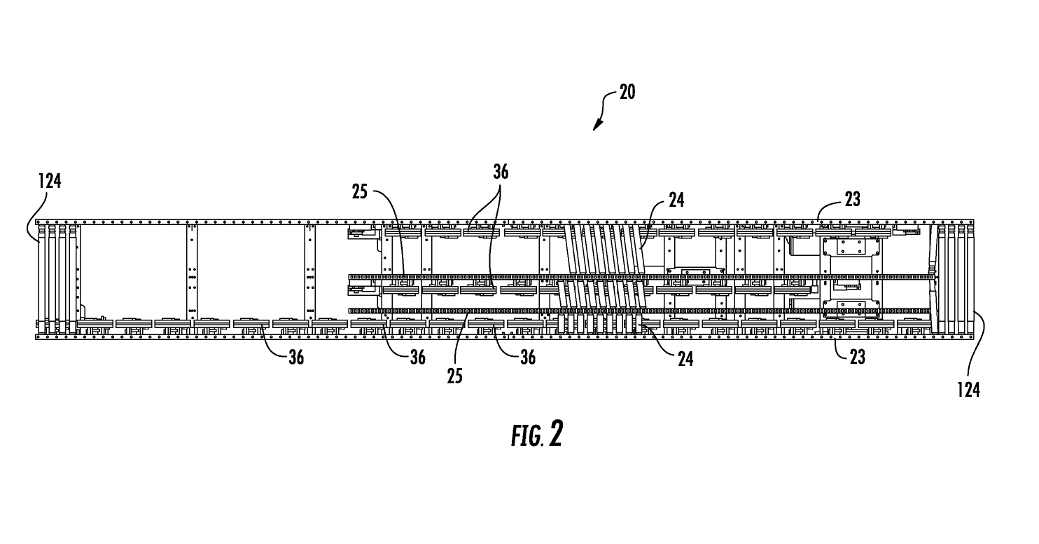

Since lanes 26 are driven at different speeds, each has a separate drive system 28a, 28b, 28c. Each drive system 28a, 28b, 28c is for the purpose of propelling the rollers 24 in that lane at its designed speed, which may be fixed or variable. Each drive system 28a, 28b, 28c includes an endless belt 30, such as a “V” shaped belt, a motor assembly 32 that is adapted to propel belt 30 and a plurality of guide assemblies 36 that are adapted to bias belt 30 against rollers 24. Motor assembly 32 includes an electric motor 31 and a gear box 33 which adjusts the rotation of the motor to the speed at which that lane is to be driven. As can be seen in FIG. 2, the gear box has a drive pulley to propel the belt and one or more idler pulleys to increase frictional wrap between the belt and drive pulley. A take-up 34 is provided for each drive system 28a, 28b, 28c in order to maintain a constant tension on belt 30.

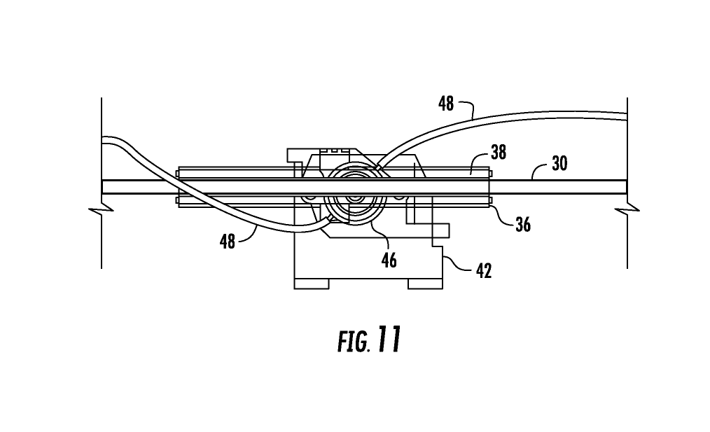

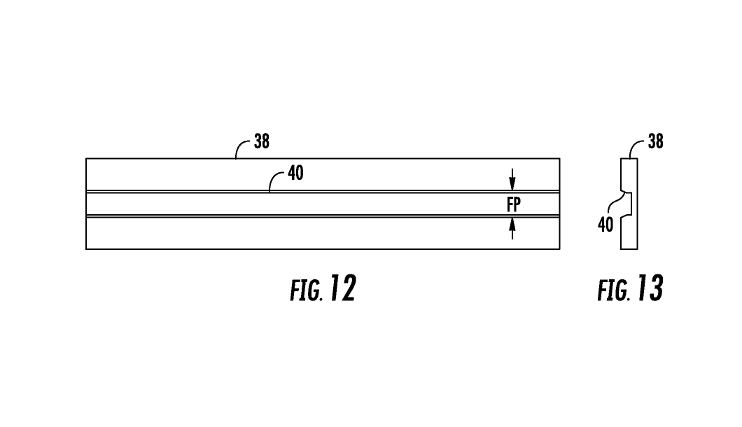

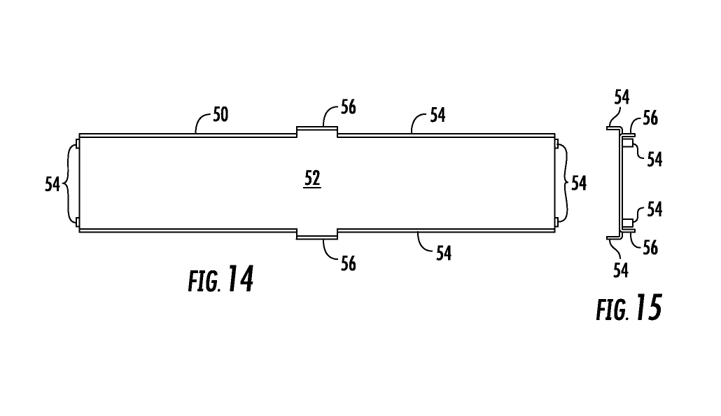

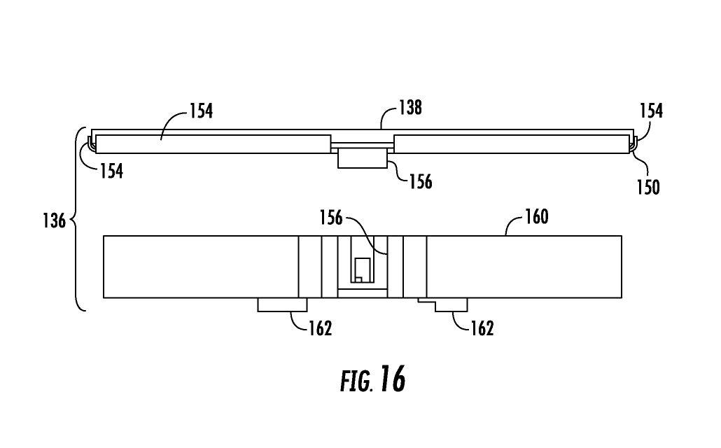

Each drive system 28a, 28b, 28c is made up of a series of guide assemblies 36 each having a block of low-friction polymers 38 and a support 22 that is adapted to press block 38 against an upper run of belt 30 to press belt 30 against rollers 24. As can best be seen in FIG. 2, each belt extends for all or at least more than half the length of conveying surface 22 and a plurality of guide assemblies 36 are provided along the length of belt 30 which is not shown in FIG. 2. Block 38 serves the additional function of keeping belt 30 aligned with its intended travel path. This is accomplished by a channel 40 formed in the block. Guide channel 40 has a footprint FP that is approximately the width of belt 30. Guide channel 40 resists lateral motion of belt 30. In the illustrated embodiment, belt 30 is a V-shaped belt. As best seen in FIGS. 12 and 13, channel 40 has sloping sides to conform to the V-shape of belt 30.

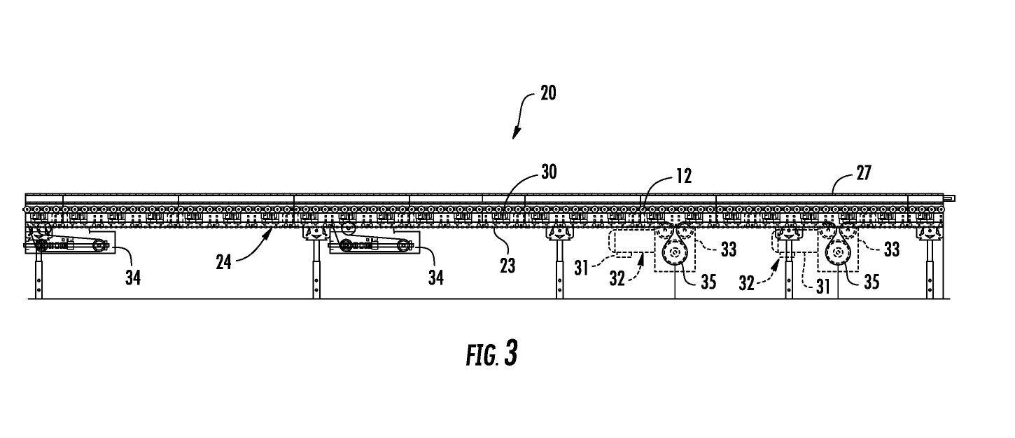

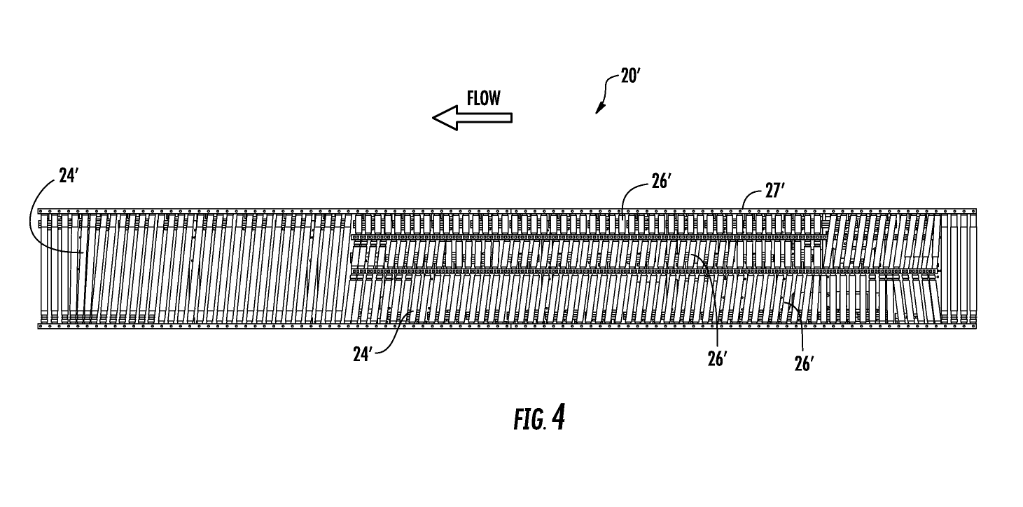

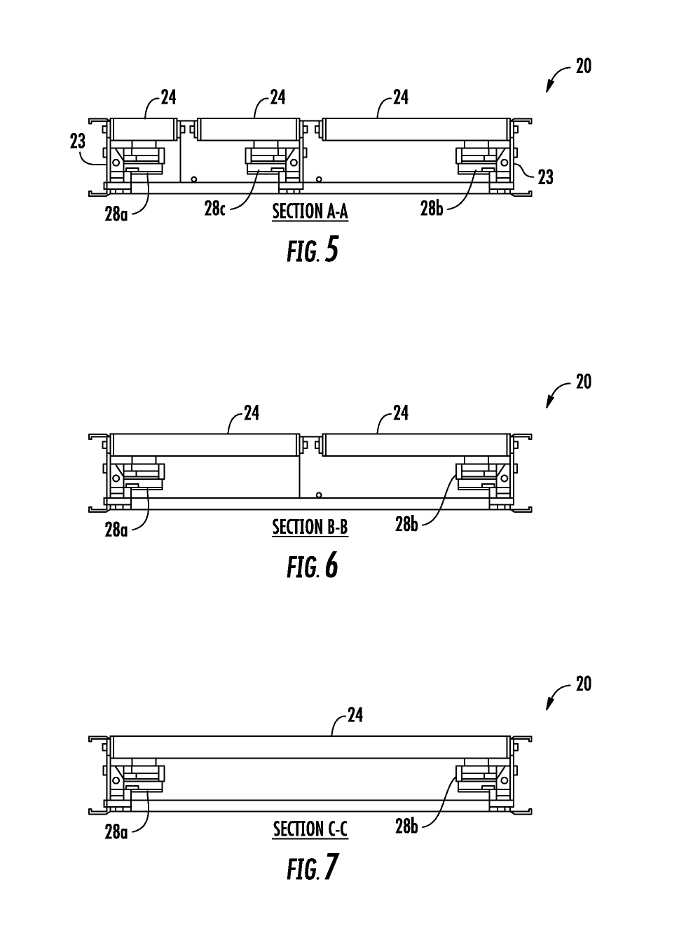

In the embodiment shown in FIG. 4, a conveyor 20′ includes lanes 26′ that drive the articles toward the right as viewed from the direction of article travel against an alignment edge 27′. The speeds of lanes 26′ are opposite those of lanes 26 of conveyor 20. Also, rollers 24′ are skewed toward the right in order to urge articles against alignment edge 37.

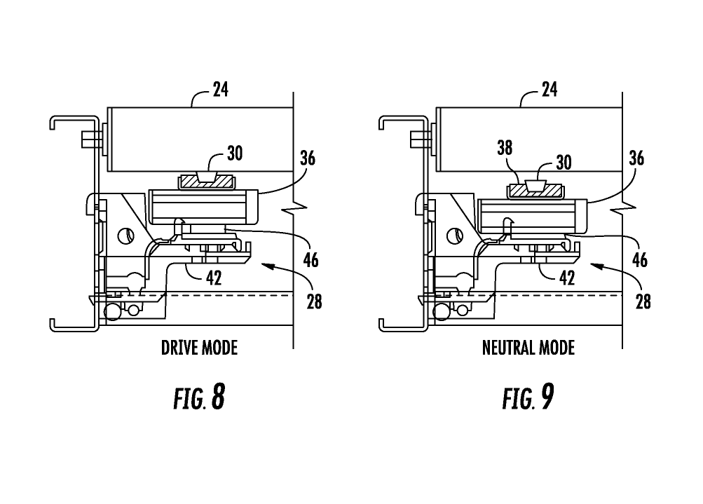

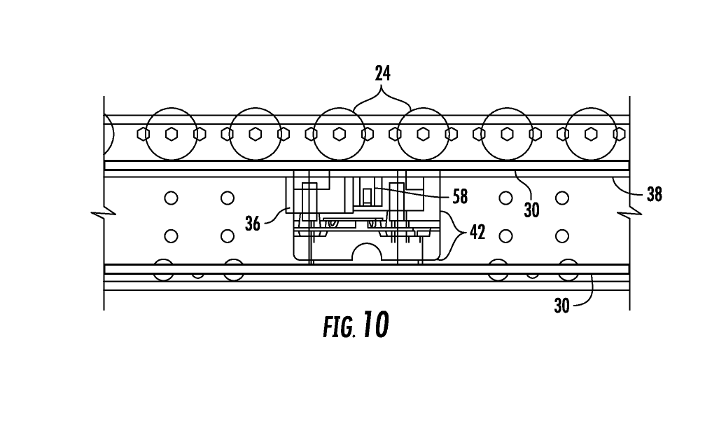

Support 42 may include a spring (not shown) that is adapted to press block 38 upwardly in order to bias the belt against the rollers. While the spring would provide a constant upward bias to drive rollers 24 continuously, it is possible to instead have an actuator 46 that is controllable such that support 42 has a drive mode in which belt 30 is pressed against rollers 24, as seen in FIG. 8, and a neutral mode in which belt 30 is not pressed against rollers 24, as seen in FIG. 9. To provide such control, support 42 includes a controllable actuator 46, such as a pneumatic cylinder. A control line 48 may be provided to one or more of supports 42 to move that actuator between the neutral and drive modes, such as by applying compressed air, or the like.

Each block 38 is made up of a low friction polymer, such as a tivar material, or the like. A tray 50, that is about the same footprint as block 38, has a bottom surface 52 that provides an even support to block 38. Sides 54 of tray 50 keep block 38 restrained. Tabs 56 guide vertical reciprocation of blocks 38 by riding in slots 58 in support 42.

In an alternative embodiment, a guide assembly 136 is made up of a low-friction block 138, that is made from a low-friction polymer similar to block 38 and including a channel (not shown) formed therein corresponding to the shape of endless belt 30. Block 138 is supported by a tray 150 having sides 154 and tabs 156 that engage slots 158 in a base 160. Base 160 provides constant support to tray 50, and thereby provides constant support to block 138. Base 160 is made form a structural plastic with webs 164 to provide lightweight rigidity. Base 160 has biasing openings 162 to receiving biasing springs (not shown) to bias base 160, and, hence, block 138 upwardly toward the rollers (not shown). Alternatively, openings 162 may receive actuators (not shown) to provide controlled intermittent actuation of the rollers.

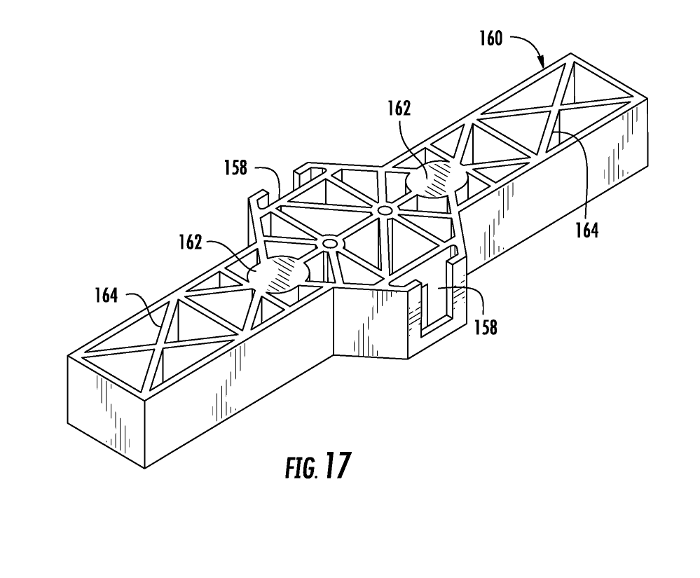

Rollers 24 include indirectly driven rollers 124 that have a driving surface 170 and a conveying surface 172 (FIGS. 18a, 18b). Driving surface 170 includes at least one groove 174 for engaging an endless member, such as an O-ring 176, for coupling to driving surface 170 of an adjacent roller 124. Rollers 124 are indirectly driven from an adjacent roller 124 via an O-ring. In turn, the end roller 124 in a chain or rollers is driven from a roller 24 that is driven by belt 30. This in to ensure that rollers 124 that are adjacent an end of belt 30 are positively driven, even if the presence of an end pulley for belt 30 may present inconsistent contact with belt 30.

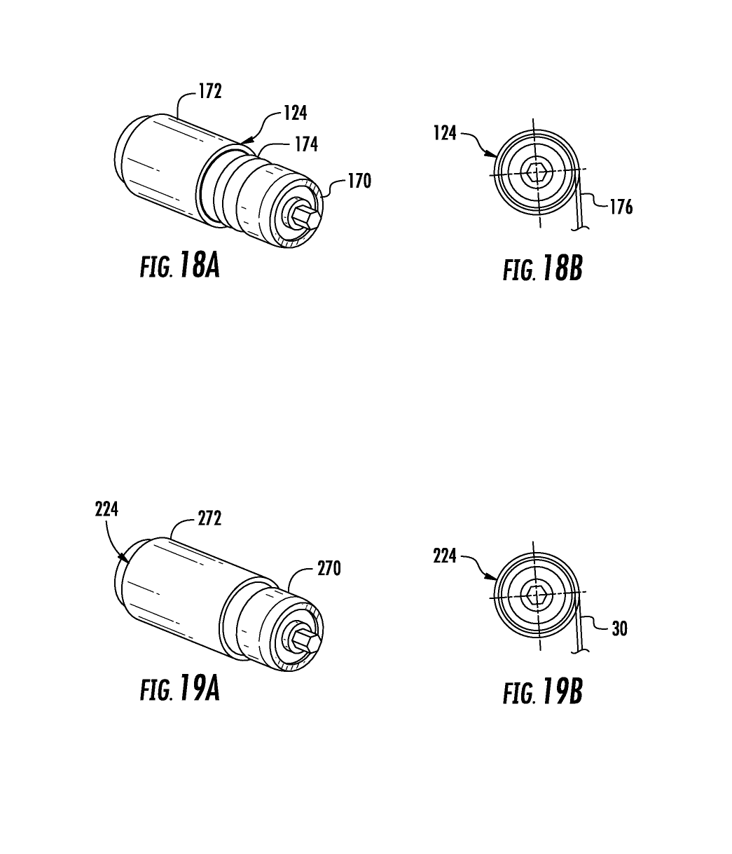

Rollers 24 include dual-diameter rollers 224 that have a driving surface 270 having a smaller diameter than a conveying surface 272 to thereby produce a speed-multiplying effect (FIGS. 19a, 19b). Driving surface 270 is generally planar in order to be frictionally engaged by endless belt 30 to drive the roller. In this fashion, conveying surface 272 is operated at a greater speed than the rollers 24 adjacent to it. This allows gaps between articles to be created or reduced where needed by producing an additional speed change along any of the lanes 26. Driving surfaces 172 and 272 are provided by polymeric sleeves slid over a smaller diameter roller.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

The embodiments of the invention in which an exclusive property or privilege is claimed are defined as follows:

1. A conveyor, comprising:
a conveying surface defined by a plurality of freely rotatable rollers; and
a drive system that is adapted to drive said rollers, wherein said drive system comprises an endless belt, a motor assembly that is adapted to propel said belt and a guide assembly that is adapted to bias said belt against said rollers, wherein said guide assembly comprises a stationary block of a low-friction polymer and a support that is adapted to press said block against an upper run of said belt to press said belt against said rollers.

2. The conveyor as claimed in claim 1 including a guide channel formed in said block, said channel having a footprint that is approximately the width of said belt.

3. The conveyor as claimed in claim 1 wherein said support comprises a spring that is adapted to press said block upwardly.

4. The conveyor as claimed in claim 1 wherein said support has a drive mode in which said belt is pressed against said rollers and a neutral mode in which said belt is not pressed against said rollers.

5. The conveyor as claimed in claim 4 wherein said support comprises a controllable actuator.

6. The conveyor as claimed in claim 5 wherein said actuator comprises a pneumatic cylinder.

7. The conveyor as claimed in claim 1 including a plurality of said guide assemblies spaced along said conveying surface.

8. The conveyor as claimed in claim 1 wherein said rollers are skewed.

9. The conveyor as claimed in claim 1 wherein said belt comprises a V-shaped belt in cross section.

10. The conveyor as claimed in claim 1 wherein said low-friction polymer comprises a tivar material.

11. A conveyor, comprising:
a conveying surface defined by a plurality of lanes, each comprising freely rotatable rollers that are skewed with respect to a longitudinal direction, wherein the conveying surface in each of said lanes is driven at a different speed from other of said lanes; and
a drive system for each of said lanes, wherein said drive system is adapted to drive said rollers in that lane, wherein said drive system comprises an endless belt, a motor assembly that is adapted to propel said belt and a guide assembly that is adapted to bias said belt against said rollers, wherein said guide assembly comprises a stationary block of low-friction polymer and a support that is adapted to press said block against an upper run of said belt to press said belt against said rollers in that lane.

12. The conveyor as claimed in claim 11 including a guide channel formed in said block, said channel having a footprint that is approximately the width of said belt.

13. The conveyor as claimed in claim 11 wherein said support comprises a spring that is adapted to press said block upwardly.

14. The conveyor as claimed in claim 11 wherein said support has a drive mode in which said belt is pressed against said rollers and a neutral mode in which said belt is not pressed against said rollers.

15. The conveyor as claimed in claim 14 wherein said support comprises a controllable actuator.

16. The conveyor as claimed in claim 15 wherein said actuator comprises a pneumatic cylinder.

17. The conveyor as claimed in claim 11 including a plurality of said guide assemblies spaced along said conveying surface.

18. The conveyor as claimed in claim 11 wherein said belt comprises a V-shaped belt in cross section.

19. The conveyor as claimed in claim 11 wherein said low-friction polymer comprises a tivar material.

20. The conveyor as claimed in claim 11 wherein at least some of said rollers comprise a driving surface and a driven surface, said driven surface having a larger diameter than said driving surface thereby producing a speed increase with respect to other of said rollers in that lane.

21. The conveyor as claimed in claim 20 wherein said driven surface is defined by a polymeric sleeve over a roller defining said driving surface.
